(19) United States
(12) Patent Application Publication
(10) Pub. No.: US 2012/0261905 A1
(43) Pub. Date: Oct. 18, 2012

(54) GOOSENECK HITCH ASSEMBLY

(76) Inventors: Anthony Hayton, Centerline, MI (US); Robert Ruby, Clarkston, MI (US); Charles Ruby, Lodi, CA (US); James R. Lexau, JR., Corvallis, OR (US)

(21) Appl. No.: 13/421,531

(22) Filed: Mar. 15, 2012

Related U.S. Application Data
(60) Provisional application No. 61/452,918, filed on Mar. 15, 2011.

(51) Int. Cl. B60D 1/06

(52) U.S. Cl. 280/511

(57) ABSTRACT

A hitch assembly including a hitch ball and a socket is disclosed. The socket is generally cylindrical and has an inner diameter being at least as large as an outer diameter of a hitch ball mounting portion. A pin receiving groove is formed in a vertical direction on the hitch ball. Additionally, at least one engagement groove encircles the diameter of the hitch ball mounting portion. The hitch ball mounting portion also includes a flattened portion. The assembly also includes a retaining pin configured for sliding in the pin receiving groove. The socket has a bottom plate including a through hole configured to receive the retaining pin when the hitch ball has been rotated so as to allow the retaining pin to slide through the through hole.

### CROSS-REFERENCE TO RELATED APPLICATIONS

The present disclosure claims the priority to U.S. Provisional Application No. 61/452,918, filed Mar. 15, 2011, said application is incorporated by reference in its entirety.

### FIELD

The present disclosure relates to ball type hitch assemblies, and in particular to a hitch assembly having a hitch ball being removably retained in a socket.

### BACKGROUND

A hitch ball is used to couple a towed vehicle, such as a trailer, to a towing vehicle, such as truck. The capacity of the towing vehicle typically dictates the size of the towed vehicle along with the hitch assembly on the towing vehicle. Various hitch assemblies allow for a variety of different sizes of towed vehicles. For example, one type of hitch ball that is used to tow heavy trailers is a gooseneck. A gooseneck hitch can include a hitch ball mounted on a towing vehicle and a hitch receiving portion on the towed vehicle, typically a cylinder. The gooseneck hitch allows the towed vehicle to rotate about the hitch ball mounted on the towing vehicle.

### BRIEF DESCRIPTION OF THE DRAWINGS

Implementations of the present disclosure will now be described, by way of example only, with reference to the attached Figures, wherein:

FIG. 1 is a first perspective view of an exemplary hitch ball according to an embodiment of the present disclosure;

FIG. 2 is a second perspective view of the exemplary hitch ball of FIG. 1;

FIG. 3 is a top plan view of the exemplary hitch ball of FIG. 1;

FIG. 4 illustrates a perspective assembly view of the exemplary hitch ball of FIG. 1 with an exemplary socket according to an embodiment of the present disclosure;

FIG. 5 illustrates a perspective view of the hitch ball received in the exemplary socket according to FIG. 4;

FIG. 6 illustrates a side phantom view of an exemplary hitch ball received within an exemplary socket according to an embodiment of the present disclosure;

FIG. 7 illustrates a top perspective view of an exemplarily socket according to an embodiment of the present disclosure;

FIG. 8 illustrates a bottom perspective view of the exemplarily socket according to FIG. 7;

FIG. 9 illustrates a top plan view of the exemplarily socket according to FIG. 7;

FIG. 10 illustrates an exemplary side perspective view of a hitch ball, an installed configuration, in an exemplarily socket according to an embodiment of the present disclosure;

FIG. 11 illustrates an exemplary socket mounted within a hitch head portion of a space frame, according to an embodiment of the present disclosure; and

FIG. 12 illustrates the exemplary socket mounted including the hitch head portion of FIG. 11 within a space frame according to an embodiment of the present disclosure.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, methods, procedures and components have not been described in detail so as not to obscure the embodiments described herein. Also, the description is not to be considered as limiting the scope of the embodiments described herein.

The present disclosure relates to a hitch assembly for coupling a towed vehicle to a towing vehicle. The towed vehicle can be a trailer and the towing vehicle can be an automobile such as a pickup truck. The hitch assembly as disclosed herein can allow the hitch ball to be removably connected to a hitch socket.

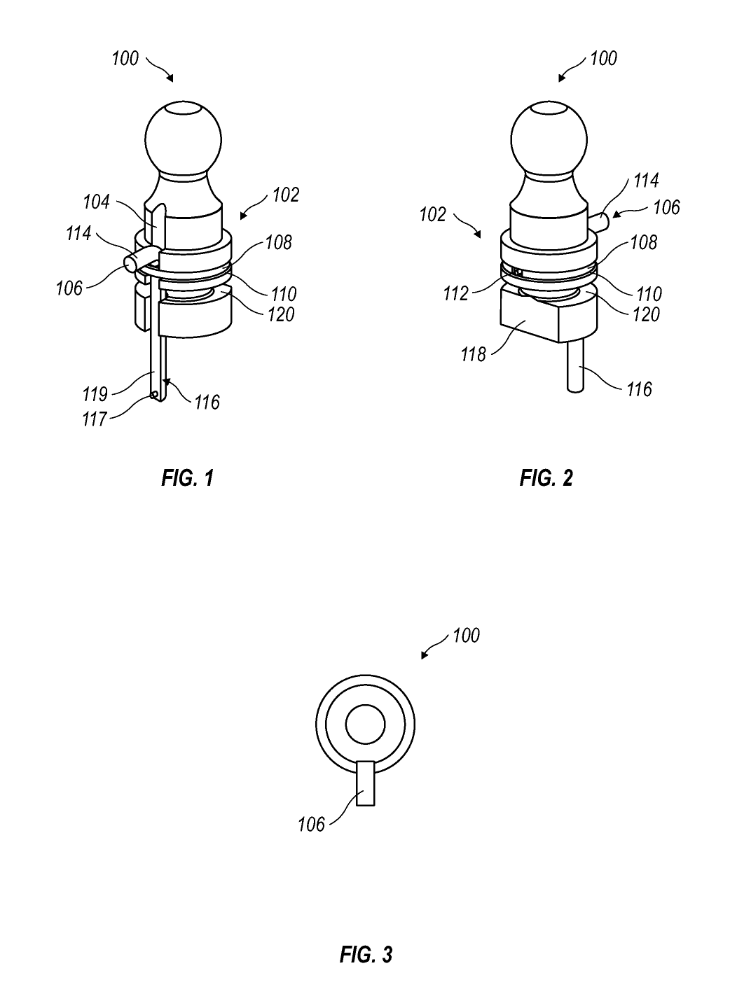

FIGS. 1-3 illustrate an exemplary hitch ball 100 according to the present disclosure. The hitch ball 100 can include a hitch ball mounting portion 102. The hitch ball mounting portion 102 can include a pin receiving groove 104. The pin receiving groove 104 can be formed in a vertical direction. The pin receiving groove 104 can be formed to slidingly receive a retaining pin 106. The retaining pin 106 can slide within the pin receiving groove 104. In at least one embodiment, the retaining pin 106 can be configured to be maintained in the installed configuration by a retaining band 108. The retaining band 108 can be a circular metal member as shown. In other embodiments, the retaining band 108 can be a spring steel member, a rubber o-ring, or any other member that is capable of retaining the retaining pin 106. Additionally, a roll pin 117 can be mounted on the retaining pin 106 and prevents the retaining pin 106 from extending beyond a predetermined position. In another embodiment, a protrusion from the retaining pin 106 replaces the roll pin 117. The protrusion can be integrally formed with the retaining pin 106. The retaining band 108 can be mounted in a retaining band groove 110. The retaining band groove 110 can be formed on the hitch ball mounting portion 102. A roll pin 112 can hold the retaining band 108 in place. In other embodiments other removable coupling mechanisms such as a screw, dowel, or clip can be implemented instead of the roll pin 112.

The retaining pin 106 as shown is L-shaped so that a first portion 114 of the retaining pin 106 is perpendicular to the second portion 116. The retaining pin 106 can have a flattened region 119. The flattened region 119 extends along a majority of the second portion 116 of the retaining pin 106. The flattened region 119 can provide for an enhanced mounting surface for the installation of pin 117, which cooperates with the retaining band 108 as described above to slidingly couple the retaining pin 106 to the hitch ball 100. While the illustrated embodiment of the retaining pin 108 includes the flattened region 119, other embodiments can have no flattened portion. Additionally, while the retaining pin 106 is illustrated as substantially cylindrical, it can take a variety of different shapes such as triangular, polygonal and the like. When the retaining pin 106 is cylindrical it can aid in sliding against groove 104. In other embodiments where the retaining pin has a different shape, the groove 104 can have a corresponding shape. Additionally as illustrated, the second portion 116 of the retaining pin 106 is substantially longer than the first portion 114. The length of the second portion 116 can be sized based on the hitch ball mounting portion 102 and the corresponding height of the socket (illustrated later). The length of the first portion 114 can be sized so as to allow an operator to easily grasp the retaining pin 106 and prohibit coupling of the towed vehicle when the hitch ball 100 is in a disengaged configuration, yet allow for coupling in the installed configuration.

The mounting portion 102 also can include a flattened portion 118. The flattened portion 118 is substantially flat. The mounting portion 102 also includes at least one engagement groove 120 encircling the diameter of the hitch ball mounting portion 102.

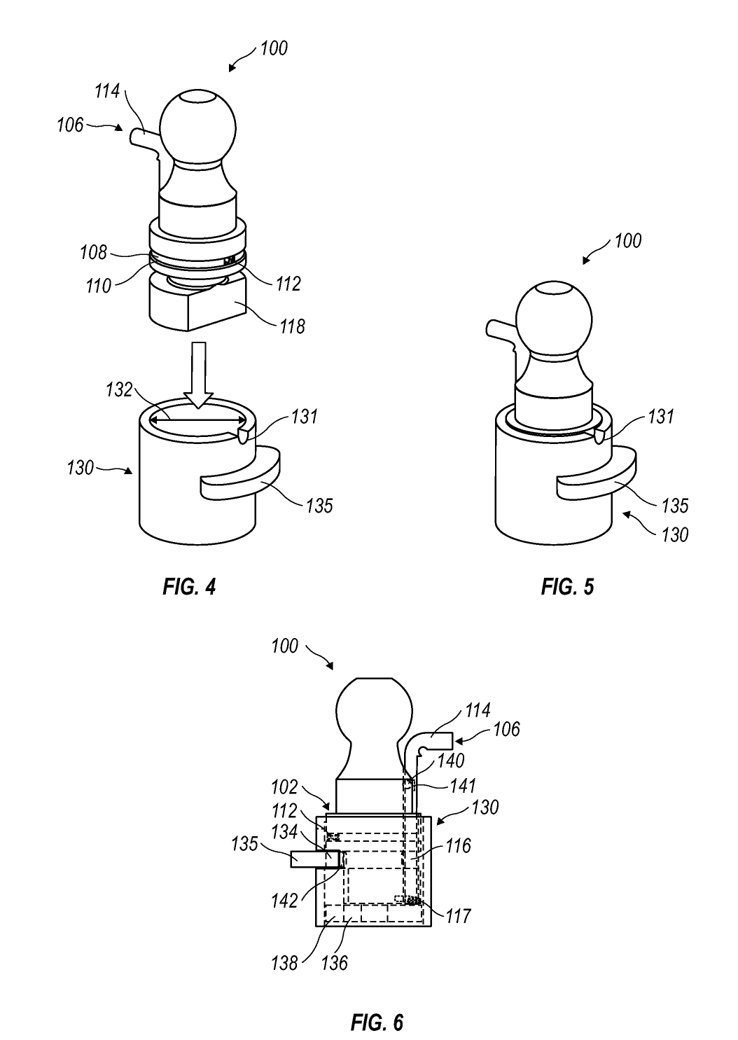

FIG. 4 illustrates the hitch ball 102 being mounted in a socket 130. The socket 130 has an inner diameter 132. The inner diameter 132 is sized to receive the hitch ball 102. The socket 130 also includes a fin (illustrated in FIG. 5 below). The fin is configured to substantially allow the hitch ball 102 to be inserted into the socket 130 when the fin is substantially aligned with the flattened portion 118 of the hitch ball 102. The retaining pin 106 as illustrated is in the disengaged configuration such that the bottom of the retaining pin 106 is raised to be above or substantially flush with the bottom of the mounting portion 102. The fin has a protruding portion 135 that extends beyond the outer surface of the socket 130. In the illustrated example, the protruding portion 135 can be configured to accommodate welding of the protruding portion 135 to the outside of the socket 130. In another embodiment, the protruding portion 135 can be omitted and the fin can be integrally formed with the socket 130. In another embodiment, the fin 134 can be welded to the socket 130 such that fin 134 does not extend beyond the exterior surface of the socket.

FIGS. 5-6 illustrate the hitch ball 100 in the intermediate disengaged configuration, wherein the hitch ball 100 has been received in the socket 130, but is not yet in the installed configuration. In the illustrated embodiment of FIGS. 5-6, the retaining pin 106 can prevent inadvertent coupling of the towed vehicle to the hitch ball 100, because the retaining pin 106 extends beyond the diameter of the hitch ball 100 in a horizontal direction.

FIG. 6 shows a portion of the socket 130, retaining pin 106, and the hitch ball 100 in phantom. As illustrated, the retaining pin 106 includes a detent mechanism 140. The detent mechanism 140 as shown is a biased ball. In other embodiments, the detent mechanism 140 can be any mechanism that provides a resistance to movement of the retaining pin 106 from at least one predetermined position. The detent mechanism 140 can be configured to provide two detent positions. In at least one embodiment the first detent position is such that the detent mechanism 140 holds the retaining pin 106 in the disengaged position. The detent mechanism 140 can also be configured to allow maintaining of the retaining pin 106 in an engaged configuration as will be described below.

The retaining pin 106 can slide in the groove 104. A gap 141 can be formed between the retaining pin 106 and the groove 104. The gap 141 as illustrated is very small and provides for slight movement of the retaining pin 106 relative to the groove 104. In at least one embodiment, the gap 141 can be near the tolerances of the groove 104 and retaining pin 106.

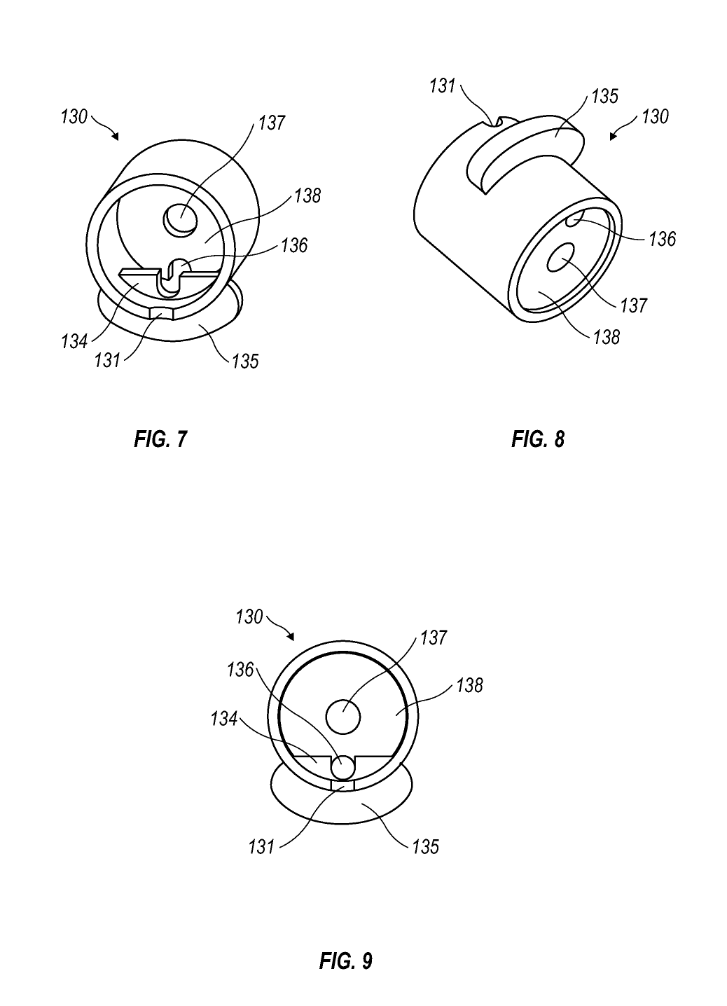

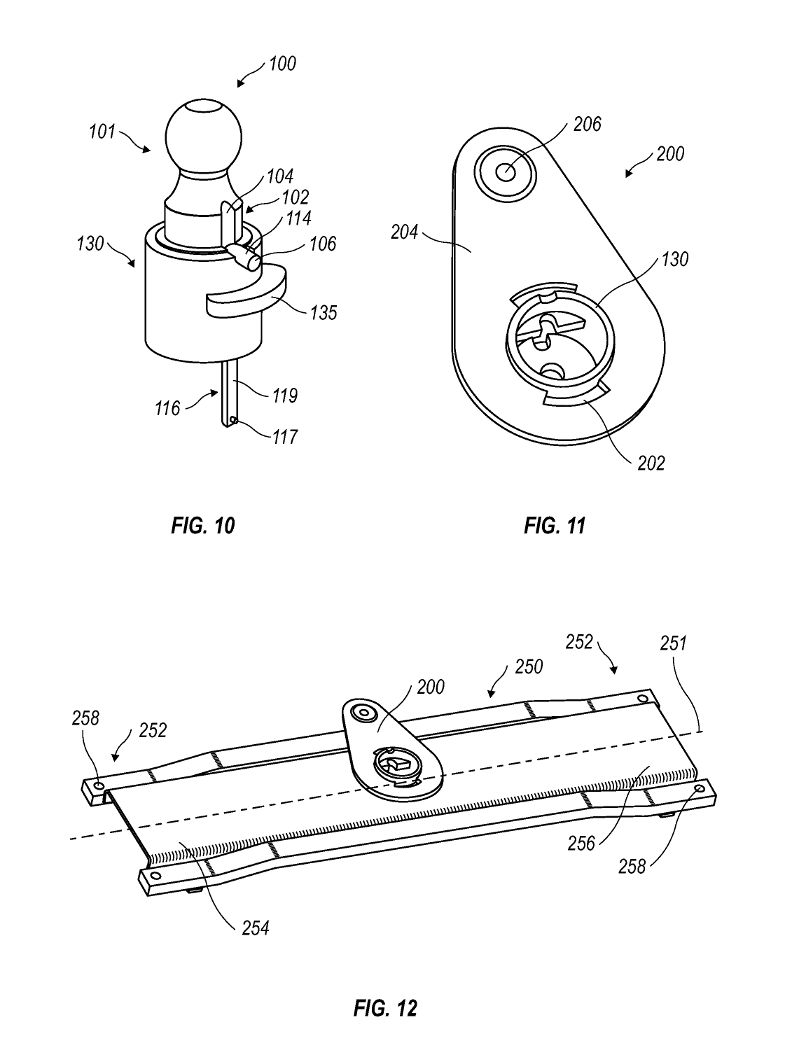

The socket 130 is shown in greater detail in FIGS. 7-9. As shown, the socket 130 has a fin 134 that protrudes inside the inside diameter of the 132. Additionally, a through hole 136 allows for the retaining pin to pass through bottom plate 138 of the socket. Additionally, the socket 130 includes a retaining pin notch 131. The retaining pin notch 131 can accommodate the receiving pin 106, when the receiving pin 106 is in an installed configuration as described in relation to FIG. 10 below.

Once the hitch ball 100 is in the intermediate disengaged configuration of FIGS. 5-6, the hitch ball 100 and the retaining pin 106 can be rotated with respect to the socket 130. In order to lock the hitch ball 100 into an installed configuration, the hitch ball 100 is rotated from the intermediate configuration of FIG. 5 to the installed configuration of FIG. 10. In the installed configuration of FIG. 10, the retaining pin 106 has passed through the through hole 136 of the socket 130. As illustrated the retaining pin 106 is lower than the engagement region 101 of the hitch ball 100 allowing the hitch ball 100 to be received within a corresponding mating portion of the hitch coupler of the towed vehicle. The retaining pin notch 131, as illustrated above, allows the retaining pin 106 to be positioned lower than it would be possible without the retaining pin notch 131. The retaining pin 106 is held in place by a detent mechanism 140 (illustrated in relation to FIG. 6). The detent mechanism 140 engages with the engagement groove 120 on the hitch ball 100. The detent mechanism 140 resists movement so as to hold the retaining pin 106 in place, but yet allow the retaining pin 106 to be moved as needed.

In the engaged configuration, the fin 134 has slid into the at least one engagement groove 120. The fin 134 provides a vertical retention mechanism when the hitch ball 100 is subjected to loads from the coupling of the towed vehicle to the towing vehicle. The surface area of the fin 134 that contacts the engagement groove 120 can be sized such that it can withstand appropriate forces. For example, the surface area can be sized for a 10,000 lb towed vehicle to a 30,000 lb towed vehicle. In other embodiments, other ratings can also apply.

In order to couple the hitch ball 100 to a towed vehicle, the socket 130 can be mounted in a head portion 200 of a space frame 250 as illustrated in FIGS. 11-12. An exemplary detailed view of the head portion 200 of the space frame 250 is illustrated in respect to FIG. 11. As shown, the socket 130 is mounted within the head portion 200. The socket 130 can be removably or permanently mounted to the head portion 200. In at least one embodiment, the socket 130 can be removably mounted to the head portion 200 by an affixment mechanism such as a bolt, screw, socket connection or some combination thereof. When the socket is permanently mounted to the head portion 200, it can be welded or bonded to the head portion 200. In yet another embodiment, the socket 130 can be integrally formed with the head portion 200. The head portion 200 can also include a fin slot 202 which accommodates the protruding portion 135 for affixing the fin 134 to pass through the upper plate 204 of the head portion 200. In other embodiments, the fin slot 202 forms a space for welding the socket 130 to head portion 200. The head portion 200 also includes an affixment region 206 that couples the head portion 200 to the 5^{th} wheel mounting rail.

FIG. 12 further illustrates the space frame 250 having the head portion 200. As shown the head portion 200 is substantially centered on the space frame 250 in at least one direction. In the illustrated embodiment, the head portion 200 has an irregular shape and is only centered with respect to the lengthwise axis 251 of the space frame 250, wherein the lengthwise axis of the space frame 250 is in the direction parallel to the longest portion, which is across the width of the page as illustrated, of the space frame 250. The space frame 250 has mounting portions 252 on the first end 254 and second end 256. The mounting portions include through holes 258. The through holes accommodate bolts (not shown) to couple the space frame 250 to the towing vehicle.

Example embodiments have been described hereinabove regarding the implementation of a hitch ball and a hitch assembly. Various modifications to and departures from the disclosed example embodiments will occur to those having skill in the art. The subject matter that is intended to be within the spirit of this disclosure is set forth in the following claims.

What is claimed is:

1. A hitch assembly comprising:
a hitch ball including a hitch ball mounting portion;
a generally cylindrical socket having an inner diameter being at least as large as an outer diameter of the hitch ball mounting portion;
the hitch ball mounting portion having a pin receiving groove formed in a vertical direction;
the hitch ball mounting portion having at least one engagement groove encircling the diameter of the hitch ball mounting portion;
a retaining pin slidingly engaged in the pin receiving groove;
the socket having a bottom plate including a through hole configured to receive the retaining pin when the hitch ball has been rotated so as to allow the retaining pin to slide through the through hole.

2. The hitch assembly further comprising a fin protruding into the inner diameter of the socket, wherein the fin requires substantial alignment of the flatten portion of the hitch ball to be installed.

3. A hitch ball comprising:
a pin receiving groove formed in a vertical direction;
at least one engagement groove encircling the diameter of a hitch ball mounting portion; and
a flattened portion.
